(19) United States
(12) Patent Application Publication
(10) Pub. No.: US 2013/0085424 A1
(43) Pub. Date: Apr. 4, 2013

(54) MECHANICAL FOOT MOVEMENT ORTHOTIC AS AN AID TO WALKING

(71) Applicants: Juan Pablo Rodríguez Vicentini, Santiago (CL); David Alexandre Bravo López, Santiago (CL)

(72) Inventors: Juan Pablo Rodríguez Vicentini, Santiago (CL); David Alexandre Bravo López, Santiago (CL)

(21) Appl. No.: 13/261,450

(22) PCT Filed: Apr. 28, 2011
(86) PCT No.: PCT/IB11/00914

§ 371 Date: Nov. 29, 2012

(30) Foreign Application Priority Data
Apr. 30, 2010 (CL) 00432

(51) Int. Cl. A61H 3/00

(52) U.S. Cl. CPC A61H 3/00
USPC 601/33

(57) ABSTRACT

The present invention relates to a mechanical orthotic that is an aid to walking, which attaches to the foot of the individual receiving treatment and to a mobile partial weight support apparatus, characterized in that it enables the individual to carry out walking and forward movement in just one operation and using the same device. Said device is essentially a mechanical orthotic that moves the foot; the device is attached to the foot of the individual and to the mobile partial weight support apparatus, consisting of a conveyor belt for the foot, from which belt extends a metal shaft with a foot support system at the end of the shaft where the foot will rest. Said conveyor belt is mounted on a matrix in the shape of the trajectory of the foot during walking. The matrix consists of a metal plate fixed to the mobile partial weight support apparatus and a system of bearings that enables the foot conveyor belt to move in order to reduce friction in the system. The orthotic is designed so that one device attaches to each foot, wherein the mobile metal shafts extend toward the individual, and are laterally fixed to the mobile partial weight support apparatus. The foot conveyor belt is in direct contact with the ground, and when moved by a therapist, the entire system (mobile partial weight support apparatus, mechanical foot movement orthotic and the individual) moves the foot conveyor belts, thereby moving the feet.

The object of this invention is a mechanical mobilizing foot orthosis, to be fixed in a partial suspension apparatus of movable weight to be the assistance on the human gait.

In the field of rehabilitation, orthoses are “elements that correct or facilitate the execution of an action, activity or movement, trying to save energy and increased safety” according to the Ministry of Health of Chile in 2009.

Within the wide range of rehabilitation techniques, devices are known that assist, facilitate and train the march, which have a partial discharge system of movable weight, needed to upright the individual to be rehabilitated and give him the sensation of weight on his feet, in order to achieve his muscle's responses and also with elements that mobilize the lower extremities, simulating normal locomotion. These mobilizing items can range from manual mobilization carried out by two or more therapists, up to technical assistiance devices or orthoses, with the ultimate goal to recover, at least partially the human gait.

Known techniques show different treatment alternatives and improved rehabilitation methodology. Initially, manually applied therapy, with the individual supported by his own arms and the legs being mobilizing by therapists. Then, came the partial suspension system of movable weight, which was installed on a treadmill machine and the mobilizing element remained being done by therapists. While both forms are still used in rehabilitation centers, currently the technique has been perfected, incorporating orthoses, which mobilize the extremities of individuals to be rehabilitated, moving from the thighs and legs of both limbs simultaneously, simulating a cycle of “normal” walk.

The already known rehabilitative technique shows different improvements, in orthoses for walking, searching for better results in the rehabilitation of the individual, achieving standardize treatments and adapting to each individual, but all devices currently work with static rehabilitation, on a treadmill or treadmills tapes.

By contrast, the present invention provides a mechanical orthosis for the assistance in walking, that is attached to the foot of the individual being treated and to the movable weight partial suspension apparatus, whose characteristics allow the individual to execute the function of walking and moving forward with the same device and in a single operation.

The device of the invention is a mechanical mobilizing foot orthosis that is attached to the individual and to the movable weight partial suspension apparatus, comprising of a foot conveyor belt, from which a metalic shaft is projected, with a foot support system at the end of it, where the foot of the individual will be supported. This conveyor belt is mounted over a mold that has the shape of the path of the foot during walking. The matrix or mold is composed of a metal plate, attached to the movable weight partial suspension device and to a bearing system, that allows mobility of the foot conveyor belt to reduce the friction on the system.

The orthosis is designed to be attached one on each foot, with movable metal shafts designed for the individual, and held laterally to a movable weight partial suspension apparatus. The foot conveyor belt is standing in direct contact with the ground, and when is moved by a therapist, the entire system (mobile weight partial suspension apparatus, plus the foot mobilizing mechanic orthesis, plus the individual itself), shifts the standing conveyor belts mobilizer and they subsequently move the feet.

To better understand the invention, it will be described based on a preferred modality, the one which is illustrated in the drawings, which has only an illustrative character, not limiting the scope of the invention, nor the dimensions or the number of pictured elements, nor the fastening means that are exemplified.

### BRIEF DESCRIPTION OF THE DRAWINGS

FIG. 1: is a schematic parallel perspective view of the movable weight partial suspension system (2), it is equipped with mechanical mode mobilizing foot orthosis.

FIG. 2: is a parallel perspective view of the mechanical mobilizing foot orthosis shown in FIG. 1.

FIG. 3: shows a parallel perspective view of the mold (4) of the orthosis of the preferred invention, positioned in the working direction with respect to the entire system.

FIG. 4: shows a parallel perspective view of the conveyor belt stand (8), attached to the base system for the foot.

FIG. 5: shows a parallel perspective view of the arrangement of cylinders (10) and bearings (11) along the mold (4).

FIG. 6: shows a parallel perspective view of the shaping of the cylinder system (10), bearing (11) and fixing rod (12), to the mold (4).

FIG. 7: shows a parallel perspective view of the arrangement of the support system for the foot (9) in relation to the mold (4) and the foot conveyor belt (8).

### DETAILED DESCRIPTION OF THE INVENTION

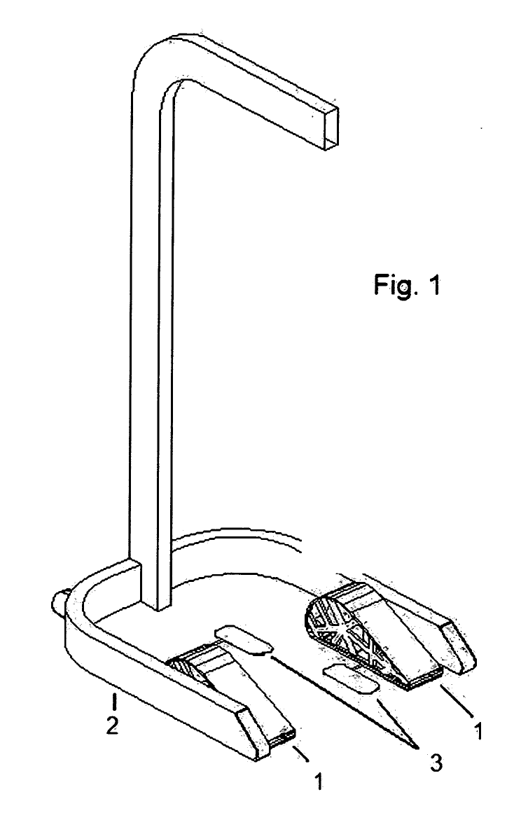

As shown in FIG. 1, the mechanical mobilizers foot orthoses (1) of the invention are fixed, in a parallel form, to the feet of the base of the movable weight partial suspension apparatus (2).

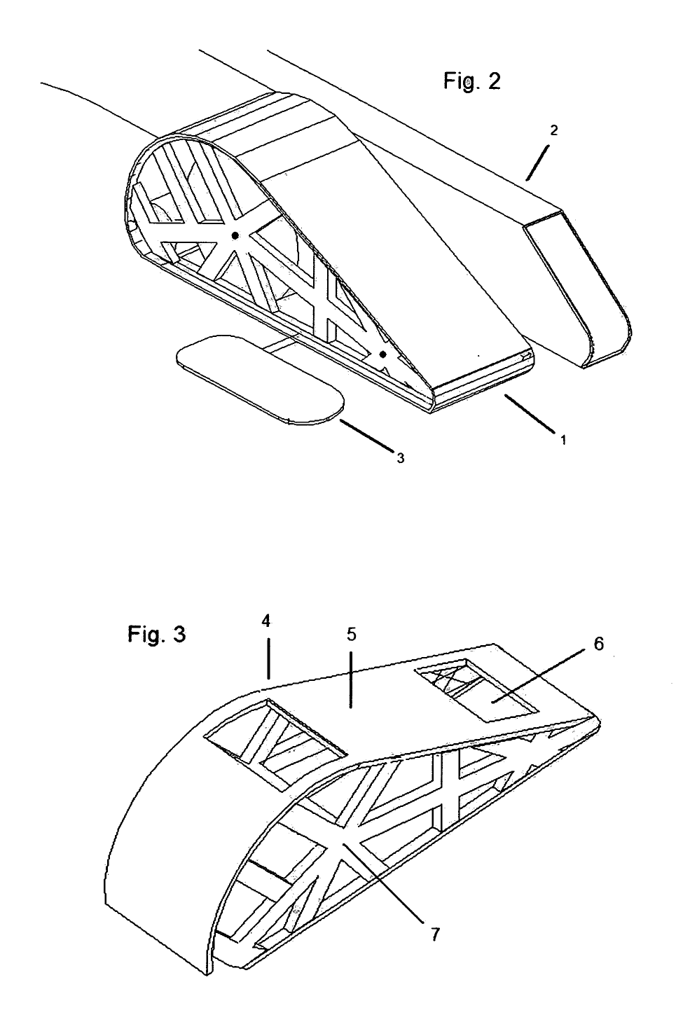

FIG. 2 shows in better detail the location of the mechanical mobilizing foot orthosis (1) relative to the feet of the base of the movable weight partial suspension system (2). Both orthoses (1) are fixed to the internal face of the feet of the movable weight partial suspension system (2), so that the center of the entire system is placed on the bases that are attached to the foot (3).

FIG. 3 shows in more detail the mold (4) of the orthosis (1), which is composed of a metal plate (5), rigid, flat, rectangular and connected at their distal ends, shaped according to the description of the trajectory of the foot in space during a step, with a rectangular recesses (6), positioned widthwise of the metal plate (5), arranged parallely along the plate, and with a system of supporting beams (7), which maintains the shape of the mold (4).

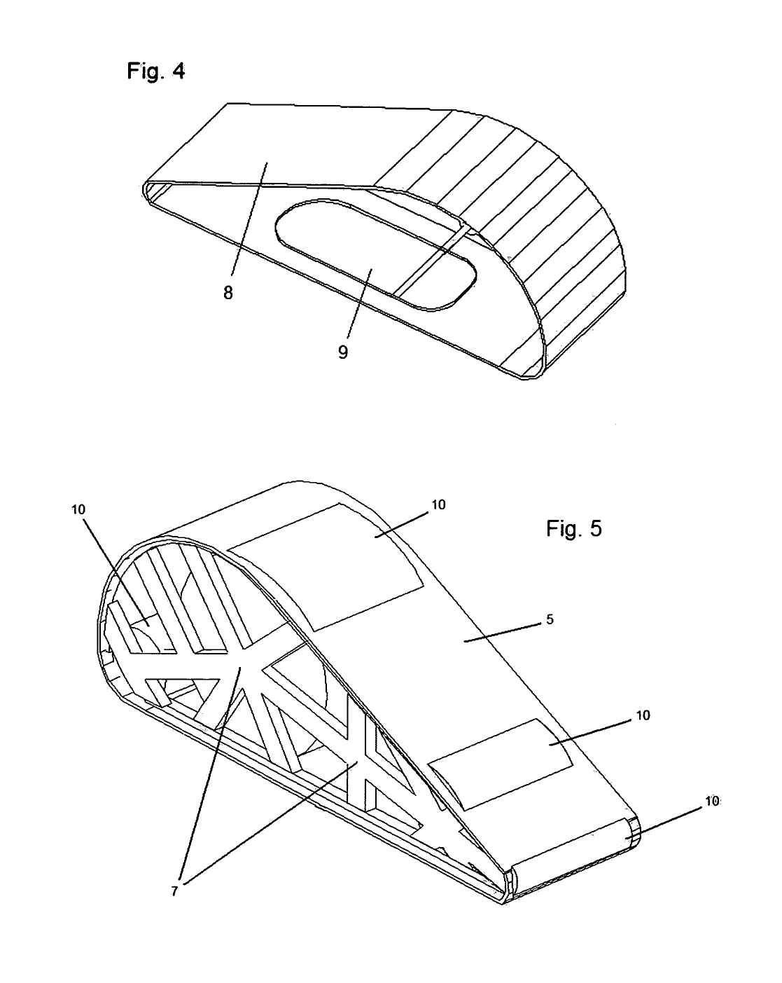

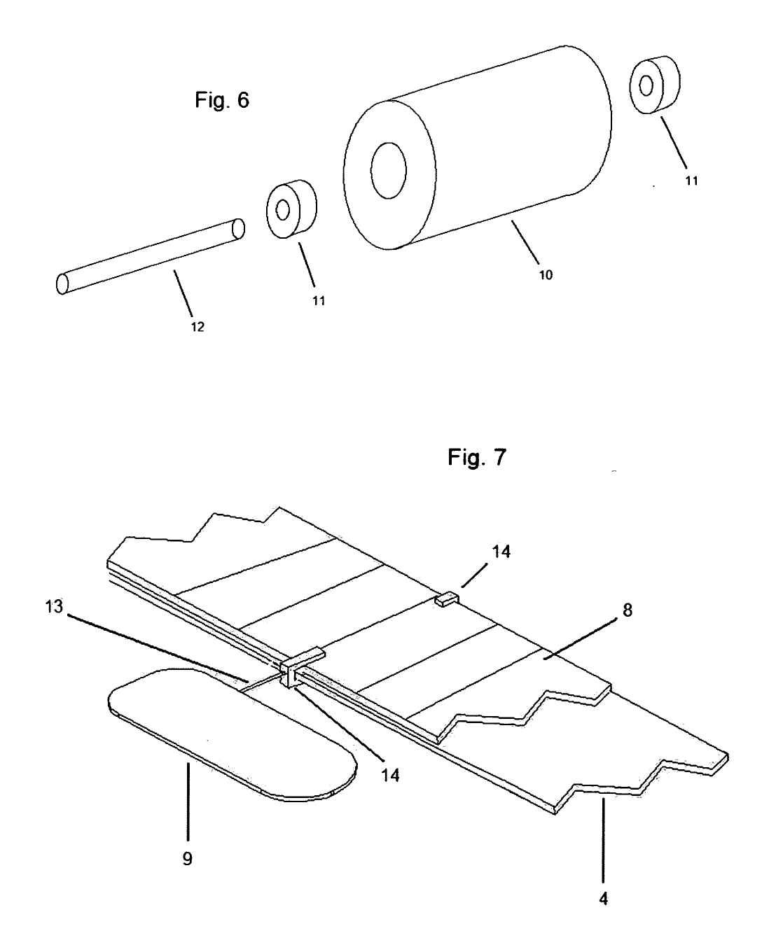

FIG. 4 shows the foot conveyor belt (8), flat, rough and flexible, which is mounted on the mold (4), taking the same shape of it. It also shows the foot support system (9), which is projected from the belt edge toward the medial portion of the system detailed in FIG. 7.

FIG. 5 shows the matrix or mold (4), in which iddler pulley systems (described in detail in FIG. 6) parallel along the metal plate (5), inside the recesses (6) of the metal plate (5), attached to it by a fixing bar (12).

FIG. 6 shows in detail a polin, comprising a cylinder (10), two bearings (11) arranged in the inner portions of the ends of the cylinder (10) and a fixing bar (12), which acts as an axis of the system, which are joined to the supporting beams (7) of the matrix (4) of the system (1).

FIG. 7 shows in detail the union of the foot support system (9), to the foot conveyor belt (8), via a metal strap (13) which passes through the width of the belt, reinforced with a union system shaped like a bracket (14), which, anchors in its upper and lower portion, both ends of the metallic shaft (13), to the system comprise by a foot conveyor belt (8), and the die (4), allowing stability, fastening and mobility to the system.

In summary, from FIGS. 4 to 6, we can see a breakdown of the invention in which we observe that FIG. 6 shows it armed on top of the metal plate (5), seen in detail in FIG. 5, distributed along matrix (4) as shown in FIG. 3. Moreover, the foot conveyor belt (8), close to the base of the foot support (9), which is shown in FIG. 4, are mounted on top the system described above, which comprises the mechanical orthosis plotted in FIG. 2, attached to the feet of the base of the movable weight partial suspension system (2), as shown in FIG. 1.

1. Mobilizing mechanical foot orthosis (1) to be fixed to a partial suspension apparatus of movable weight (2), which allows simultaneously the functions of walk and forward displacement of the individual, with the same device and in one operation, characterized that it consists mainly of:
a) a rigid matrix (4), comprising a metal plate (5), attached to the partial suspension apparatus of movable weight (2).
b) a system of idler bearings consisting in rollers (11) and cylinders (10), placed on the metal plate (5), of the matrix (4), using a fixing bar (12):
c) a foot belt conveyor (8), over the system of idler bearings and metalic plate (5) fixed to the matriz (4);
d) a metallic shaft (13), of cylindrical shape, projected from the foot conveyor belt (8), with a joint system in the form of the strap bracket (14), fixed to the belt and to the base that supports the foot;
e) a base that supports the foot (9), flexible and mounted to a metal shaft (13), which is attached to the foot conveyor belt (8);

2. Mobilizing mechanical foot orthosis (1), to be secured to a partial suspension device of movable weight (2), according to claim 1, characterized by the fact that the matrix (4), of the movilizing mechanic foot orthosis (1), has semi-elliptical shape (foot trajectory during gait).

3. Mobilizing mechanical foot orthosis (1), to be fixed to a suspension apparatus of movable weight part (2), according to claim 1 or 2, characterized by being roughened, moldable and flexible.

4. Mobilizing mechanical foot orthosis (1), to be fixed to a suspension apparatus of movable weight (2), according to claim 1 or 2, characterized by a metal plate (5) attached at their distal ends, smooth, flat, semi-elliptical, with recesses.
